(19) United States
(12) Patent Application Publication
(10) Pub. No.: US 2021/0088783 A1
(43) Pub. Date: Mar. 25, 2021

(54) LAMINATED GLASS FOR IMPLEMENTING HUD FUNCTION

(71) Applicant: SAINT-GOBAIN GLASS FRANCE, COURBEVOIE (FR)

(72) Inventors: Ce SHI, COURBEVOIE (FR); Yunxin GU, COURBEVOIE (FR); Chong ZHOU, COURBEVOIE (FR)

(21) Appl. No.: 16/498,916

(22) PCT Filed: Mar. 27, 2018
(86) PCT No.: PCT/CN2018/080649

§ 371 Date: Sep. 27, 2019

(30) Foreign Application Priority Data
Mar. 31, 2017 (CN) 201710207804.2

(51) Int. Cl. G02B 27/01; B32B 17/10; B32B 3/26; G02B 1/11; B64C 1/14

(52) U.S. Cl. CPC G02B 27/0101; G02B 2027/012; B32B 17/10541; B32B 17/10761; B32B 3/263; B32B 17/10201; G02B 1/11; B64C 1/1492; B32B 2307/416; B32B 2605/006; B32B 2250/03; B32B 2250/04; B32B 2250/40; B32B 2255/20; B32B 2255/28; B32B 2307/732; B32B 17/10036

(57) ABSTRACT

A laminated glass for implementing HUD function, the laminated glass including an outer glass layer; an inner glass layer; a PVB film located between the outer glass layer and the inner glass layer; wherein the PVB film is of a uniform thickness, the laminated glass further includes a reflection film.

### TECHNICAL FIELD

The present invention relates to the technical field of glass, and particularly to a laminated glass for implementing HUD function.

### BACKGROUND ART

HUD (head up display) can enable a driver to see important information needed by him without requiring him to make his head down, thereby reducing a frequency at which a pilot is required to make his head down to view a meter, so as to avoid interruption of attention and losing of control over situation awareness. Thus, HUD is normally applied to aircrafts and premium types of vehicles as a travelling auxiliary instrument.

At present, HUD generally uses front windshields of aircrafts or vehicles to perform display, and these front windshields are normally a laminated glass, that is, these front windshields have both inner and outer interfaces and will form two images at different positions and with very close brightness, so they look like terrible ghosts to the driver. To solve this problem, a general practice at present is using, in a laminated glass, a PVB film having a wedge-shaped cross section with a wedge angle to adjust the imaging position of the outer interface, so that the object of eliminating ghosts can be achieved.

However, a PVB film having a wedge-shaped cross section, due to its special shape, has a higher manufacture cost, thus resulting in a very expensive sales price thereof. Generally, the price of a PVB film having a wedge-shaped cross section is several times that of a common PVB film with a uniform thickness. In addition, PVB films having a wedge-shaped cross section presently on the market are normally formed by extrusion molding process, and due to limitations of the extrusion molding process, a thus formed PVB film having a wedge-shaped cross section is at most of a wedge-shaped cross section in one direction while its cross section in another direction stays uniform and invariant. However, having a wedge-shaped cross section in only one direction still has limitations when large-area HUDs are considered, because for a HUD whose cross section is wedge-shaped in one direction, imaging on the HUD will become blurred when the HUD is viewed by the driver from other angles. For example, when the HUD is viewed from a certain angle, imaging is clear, but when the HUD is viewed from another angle, imaging on the HUD still will have ghosts at this angle since the shape of the cross section of the PVB film at this angle is uniform and invariant, thus making the driver unable to clearly see data displayed on the HUD and thus have to adjust his viewing angle, thereby resulting in a distraction of attention, thus producing certain latent issues against safe driving.

To solve the above problem, one solution at present is providing a glass only capable of reflecting light at a certain wavelength in a specific laser emitted, and performing HUD imaging on the glass with the light at the certain wavelength. However, light sources required by the above apparatus are generally specific narrow band emitters. Thus, the method lays higher requirements on the apparatus and cannot apply universally.

### SUMMARY OF THE INVENTION

Thus, to overcome the above deficiency in the prior art, the present invention provides a novel laminated glass window for implementing HUD function, which uses a reflection film such that a contrast ratio of the brightness of images formed on an outer glass layer and an inner glass layer of the laminated glass increases to thereby eliminate “ghosts”. Thus, the laminated glass for implementing HUD function may use a common PVB film with a uniform thickness at a lower price on the market, such that a manufacture cost of the laminated glass for implementing HUD function significantly decreases.

According to one aspect of the present invention, there is provided a laminated glass for implementing HUD function, the laminated glass comprising:

an outer glass layer;

an inner glass layer;

a PVB film located between the outer glass layer and the inner glass layer;

wherein the PVB film is of a uniform thickness, at least one of a side of the outer glass layer facing away from the PVB film and a side of the inner glass layer facing away from the PVB film is provided with a reflection film.

According to another aspect of the present invention, wherein only the side of the outer glass layer facing away from the PVB film is provided with a reflection film.

According to another aspect of the present invention, wherein only the side of the inner glass layer facing away from the PVB film is provided with a reflection film.

According to another aspect of the present invention, wherein each of the outer side of the outer glass layer and the side of the inner glass layer facing away from the PVB film is provided with a reflection film respectively.

According to another aspect of the present invention, wherein the reflection film is a reflection-increasing layer or an anti-reflection layer.

According to another aspect of the present invention, wherein when each of the side of the outer glass layer facing away from the PVB film and the side of the inner glass layer facing away from the PVB film is provided with a reflection film respectively, one of the two reflection films is a reflection-increasing layer, and the other thereof is an anti-reflection layer.

According to another aspect of the present invention, wherein the reflection-increasing layer or the anti-reflection layer is monolayer or multilayer.

According to another aspect of the present invention, wherein the reflection-increasing layer causes a reflectivity of light projected onto the glass layer provided with the reflection-increasing layer to reach up to 6-9%, preferably 9%. The anti-reflection layer causes a reflectivity of light projected onto the glass layer provided with the anti-reflection layer to reach up to 0.1-1%, preferably 0.1%.

### BRIEF DESCRIPTION OF THE DRAWINGS

The above and other features, properties and advantages of the present invention will become clearer from the following descriptions combined with drawings and detailed embodiments, wherein:

FIG. 1 schematically illustrates a cross section diagram of a laminated glass for implementing HUD function in the prior art, wherein between an inner glass layer and an outer glass layer there is a wedge-shaped PVB film;

FIG. 2 schematically illustrates a cross section diagram of one embodiment of a laminated glass for implementing HUD function according to the present invention, wherein between an inner glass layer and an outer glass layer there is a PVB film with a uniform thickness, and wherein a reflection film is provided on an outer side of the outer glass layer;

FIG. 3 schematically illustrates a cross section diagram of another embodiment of the laminated glass for implementing HUD function according to the present invention, wherein between an inner glass layer and an outer glass layer there is a PVB film with a uniform thickness, and wherein a reflection film is provided on an inner side of the inner glass layer;

FIG. 4 schematically illustrates a cross section diagram of still another embodiment of the laminated glass for implementing HUD function according to the present invention, wherein between an inner glass layer and an outer glass layer there is a PVB film with a uniform thickness, and wherein reflection films are provided on both an outer side of the outer glass layer and an inner side of the inner glass layer respectively.

### DETAILED DESCRIPTION OF THE EMBODIMENTS

In the following detailed descriptions of preferred embodiments, reference will be made to the appended drawings constituting a part of the present invention. In the appended drawings, specific embodiments capable of implementing the present invention are shown by way of examples. The exemplary embodiments do not aim to enumerate all embodiments according to the present invention. It could be understood that without departing from the scope of the present invention, other embodiments may be utilized, and structural or logical modifications may also be made. Thus, the following detailed descriptions are not limitative, and the scope of the present invention is defined by the appended claims.

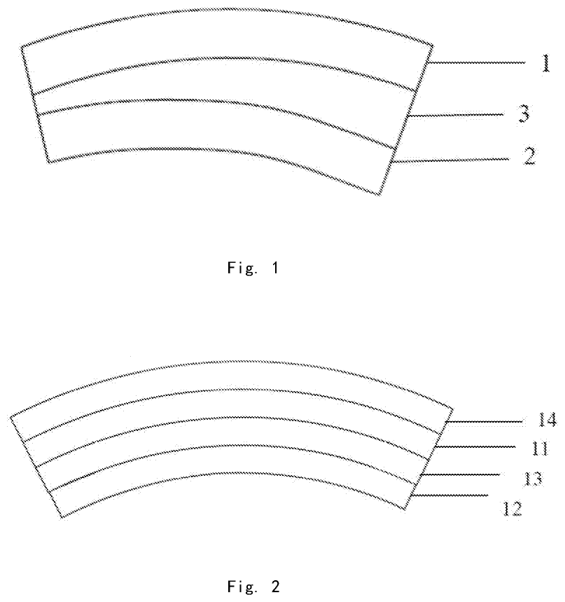

FIG. 1 is a cross section diagram of a laminated glass for implementing HUD function in the prior art. Referring to FIG. 1, between an inner glass layer and an outer glass layer there is a wedge-shaped PVB film. In the prior art, the wedge-shaped PVB film is generally obtained by extrusion molding process.

In FIG. 1, a basic mechanism according to which the laminated glass having a wedge-shaped cross section eliminates “ghosts” formed due to mutual overlapping between images generated by the inner and outer glass layers is as follows: since a cross section of a PVB film 3 is wedge-shaped and a thickness of the PVB film 3 is not uniform, its reflection angle varies among positions where the thickness of the PVB film 3 varies, and by using this varying reflection angle, it is made possible to ultimately focus two images formed by the outer glass layer 1 and the inner glass layer 2 to one position, thereby forming only one clear image. However, since forming the PVB film 3 having the wedge-shaped cross section lays higher requirements on the molding process, and the process is relatively complicated, thus resulting in an increase in a manufacture cost of the film. The price of PVB films having a wedge-shaped cross section on the market at present are much higher than that of common PVB films with a uniform thickness, and the price of some wedge-shaped PVB films are about eight times that of the common PVB films. Moreover, once an angle at which a driver looks at the display deviates from the adjusted angle of the PVB film, “ghosts” will inevitably appear again.

In view of the above problem, the present invention provides a laminated glass for implementing HUD function, wherein a reflection film is provided on at least one of a side of an inner glass layer facing away from a PVB film and a side of an outer glass layer facing away from the PVB film, and in this case, the PVB film between the inner glass layer and the outer glass layer may be a PVB film with a uniform thickness.

In actual use, it may be regarded as such that the side of the inner glass layer facing away from the PVB film is an inner side of the inner glass layer, and that the side of the outer glass layer facing away from the PVB film is an outer side of the outer glass layer. The reflection film may select a reflection-increasing layer and/or an anti-reflection layer, and both the reflection-increasing layer and the anti-reflection layer herein may be purchased from the market or obtained by the conventional methods in the art. The reflection-increasing layer may be formed by preparing an oxide coating liquid by for example sol-gel method, then uniformly applying the coating liquid on a glass surface by methods such as roller coating, spraying and the like, and thereafter subjecting it together with the glass to hot bending, or tempering, and may also be formed by wet chemical method, evaporation plating, or sputtering method. Materials of the reflection-increasing layer may be selected from oxides such as titanium oxide, barium oxide and the like.

The anti-reflection layer may be a porous silicon oxide layer. The forming method of the anti-reflection layer may be: applying a silicon oxide sol of 10-20 nm uniformly on a glass surface by roller coating, and thereafter subjecting it together with the glass to hot bending, or tempering.

FIG. 2 schematically illustrates a cross section diagram of a laminated glass for implementing HUD function according to the present invention, wherein between an inner glass layer 12 and an outer glass layer 11 there is a PVB film 13 with a uniform thickness. Specifically, the PVB film 13 may be chosen from the PVB films with a uniform thickness which are commonly found on the market. The thickness of the PVB film is preferably 0.76 mm, and PVB films with other appropriate thicknesses may also be applicable. And, a reflection film 14 is provided on an outer side of the outer glass layer 11. The reflection film 14 may be either an anti-reflection layer or a reflection-increasing layer. In addition, the reflection film 14 may be either a multilayer reflection film or a monolayer reflection film. The thickness of the outer glass layer 11 may be 2.1 mm, 1.8 mm or 1.6 mm. The thickness of the inner glass layer may be 2.1 mm, 1.8 mm or 1.6 mm. Of course, inner and outer glass layers with other appropriate thicknesses may also apply. When the reflection film 14 is an anti-reflection layer, a basic mechanism according to which the laminated glass implements HUD function is as follows: when a projector (not shown) projects light onto the laminated glass, since the anti-reflection layer is provided on the outer glass layer, light reflected off the outer side of the outer glass layer is reduced, and preferably, a reflectivity of 4% may be reduced to 0.5%, which is one eighth of the original reflectivity; thus, the brightness of the image formed by the outer glass layer is so low that it may almost be ignored. However, light on the inner glass layer is properly reflected, so the brightness of the image formed by the inner glass layer is normal and clear. Thus, even if the image of a low brightness which is formed by the reflection on the outer glass layer and the image of a normal brightness which is formed by the reflection on the inner glass layer do not coincide at the same position, since the brightness of the two images differ so greatly that the image of the low brightness may almost be ignored, thus, when viewing the displayed screen, the driver will only notice the image formed by the reflection on the inner glass layer, and can clearly see the information displayed by the image, without being disturbed by the image of the low brightness which is formed by the outer glass layer. When the reflection film 14 is a reflection-increasing layer, a basic mechanism according to which the laminated glass implements HUD function is as follows: when a projector (not shown) projects light onto the laminated glass, since the reflection-increasing layer is provided on the outer glass layer, light reflected off the outer glass layer is enhanced, and preferably, may be enhanced by 2 times, from an original 4% to a reflectivity of 8%, thus, the brightness of the image formed by the outer glass layer is so high that it is much higher than the brightness of the image formed by the reflection on the inner glass layer. Thus, due to the notable difference in brightness between the two images, when viewing the displayed screen, the driver generally will notice the image with the very high brightness which is displayed by the outer glass layer, without being disturbed by the image formed by the inner glass layer.

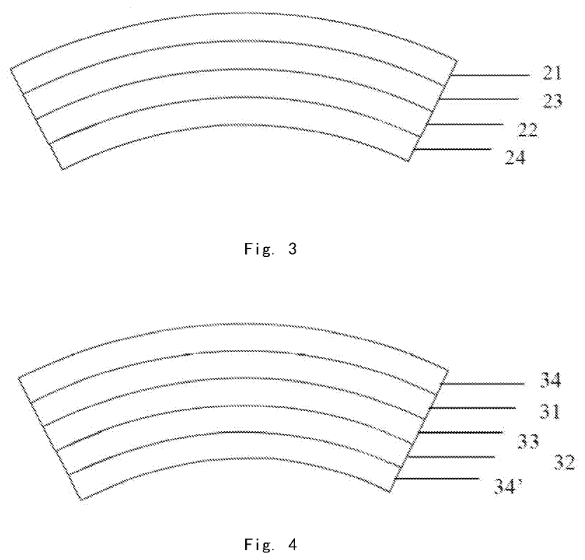

FIG. 3 schematically illustrates a cross section diagram of a laminated glass for implementing HUD function according to the present invention, wherein between an inner glass layer 22 and an outer glass layer 21 there is a PVB film 23 with a uniform thickness, and wherein a reflection film 24 is provided on an inner side of the inner glass layer 22. Wherein, the PVB film 23 may be chosen from PVB films with a uniform thickness which are commonly found on the market. The thickness of the PVB film is preferably 0.76 mm, and PVB films with other appropriate thicknesses may also be applicable. The thicknesses of the outer glass layer 21 and the inner glass layer 22 may both be 2.1 mm, 1.8 mm or 1.6 mm. Of course, inner and outer glass layers with other appropriate thicknesses may also apply. Specifically, the reflection film 24 may be either an anti-reflection layer or a reflection-increasing layer. In addition, the reflection film 24 may be either a multilayer reflection film or a monolayer reflection film. When the reflection film 24 is an anti-reflection layer, a basic mechanism according to which the laminated glass implements HUD function is as follows: when a projector (not shown) projects light onto the laminated glass, since the anti-reflection layer is provided on the inner side of the inner glass layer 22, light reflected off the inner glass layer 22 is reduced, and preferably, may be reduced from an original 4% to a reflectivity of 0.1%, which is one fortieth of the original reflectivity; thus, the brightness of the image formed by the inner glass layer 22 is so low that it may almost be ignored. However, light on the outer glass layer 21 is properly reflected, so the brightness of the image formed by the outer glass layer 21 is normal and clear. Thus, even if the image of the normal brightness which is formed by the reflection on the outer glass layer and the image of the low brightness which is formed by the reflection on the inner glass layer do not coincide at the same position, since the brightness of the two images differ so greatly that the image of the low brightness may almost be ignored. Thus, when viewing the displayed screen, the driver will only notice the image of the normal brightness which is displayed by the outer glass layer, and can clearly see the information displayed by the image, without being disturbed by the image of the low brightness which is formed by the inner glass layer. When the reflection film 24 is a reflection-increasing layer, a basic mechanism according to which the laminated glass implements HUD function is as follows: when a projector (not shown) projects light onto the laminated glass, since the reflection-increasing layer is provided on the inner side of the inner glass layer 22, light reflected off the inner glass layer 22 is greatly enhanced, and preferably, may be enhanced by more than 2 times, from an original 4% to a reflectivity of 9%; thus, the brightness of the image formed by the inner glass layer 22 is so high that it is much higher than the brightness of the image formed by the reflection on the outer glass layer. Thus, due to the notable difference in brightness between the two images, when viewing the displayed screen, the driver generally will notice the image of the very high brightness which is displayed by the inner glass layer, without being disturbed by the image formed by the outer glass layer. In the present embodiment, when the reflection film 24 is a reflection-increasing layer and is provided on the inner side of the inner glass layer 22, a fuzzy value of the formed image which is measured on transparent glass is 0.48, and a fuzzy value of the formed image which is measured on green glass is 0.4.

FIG. 4 schematically illustrates a cross section diagram of a laminated glass for implementing HUD function according to the present invention, wherein between an inner glass layer and an outer glass layer there is a PVB film with a uniform thickness, and wherein reflection films are provided on both an outer side of the outer glass layer and an inner side of the inner glass layer respectively. Wherein, the PVB film 33 may be chosen from PVB films with a uniform thickness which are commonly found on the market. The thickness of the PVB film is preferably 0.76 mm, and PVB films with other appropriate thicknesses may also be applicable. The thickness of the outer glass layer 31 may be 2.1 mm, 1.8 mm or 1.6 mm. The thickness of the inner glass layer may be 2.1 mm, 1.8 mm or 1.6 mm. Of course, inner and outer glass layers with other appropriate thicknesses may also apply. Wherein, the reflection film 34 on the outer side of the outer glass layer 31 may be either an anti-reflection layer or a reflection-increasing layer, and the reflection film 34′ on the inner side of the inner glass layer 32 is a reflection-increasing layer or an anti-reflection layer which functions oppositely thereto. When the reflection film 34 is an anti-reflection layer and the reflection film 34′ is a reflection-increasing layer, a basic mechanism according to which the laminated glass implements HUD function is as follows: when a projector (not shown) projects light onto the laminated glass, since the anti-reflection layer is provided on the outer glass layer, light reflected off the outer side of the outer glass layer is reduced, and preferably, may be reduced from an original 4% to a reflectivity of 0.5% or even 0.1%, which is less than one eighth of the original reflectivity; thus, the brightness of the image formed by the outer glass layer is so low that it may almost be ignored. Furthermore, since the reflection-increasing layer is provided on the inner glass layer 32, light reflected off the inner side of the inner glass layer 32 is enhanced, and preferably, may be enhanced by more than 2 times, from an original 4% to a reflectivity of 8% even up to 9%. Thus, even if the image of the low brightness which is formed by the reflection on the outer glass layer 31 and the image of the high brightness which is formed by the reflection on the inner glass layer 32 do not coincide at the same position, since the brightness of the two images differs so greatly, by a brightness difference of more than 16 times, that the image of the low brightness may be ignored in contrast to the image with the enhanced brightness. When viewing the displayed screen, the driver will only notice the image formed by the reflection on the inner glass layer, and can clearly see the information displayed by the image, without being disturbed by the image of the low brightness which is formed by the outer glass layer. And vice versa, when the reflection film 34 is a reflection-increasing layer and the reflections film 34′ is an anti-reflection layer. In conclusion, it should be understood that the embodiments described above are only meant to describe but not to limit the present invention. Those skilled in the art should understand that alterations and modifications may be made to the present invention without departing from the spirit and scope of the present invention. The above alterations and modifications are regarded as within the scope of the present invention and the appended claims. The scope of protection of the present invention is defined by the appended claims. In addition, any reference numeral in the claims should not be construed as limitations to the invention. The verb “comprise” and its variants do not exclude other elements or steps than those claimed in the claims. The indefinite article “a/an” preceding an element or step does not exclude more such elements or steps.

1. A laminated glass for implementing HUD function, the laminated glass comprising:
an outer glass layer;
an inner glass layer; and
a PVB film located between the outer glass layer and the inner glass layer;
wherein the PVB film is of a uniform thickness, and at least one of a side of the outer glass layer facing away from the PVB film and a side of the inner glass layer facing away from the PVB film is provided with a reflection film.

2. The laminated glass according to claim 1, wherein only the side of the outer glass layer facing away from the PVB film is provided with a reflection film.

3. The laminated glass according to claim 1, wherein only the side of the inner glass layer facing away from the PVB film is provided with a reflection film.

4. The laminated glass according to claim 1, wherein each of the side of the outer glass layer facing away from the PVB film and the side of the inner glass layer facing away from the PVB film is provided with a reflection film respectively.

5. The laminated glass according to claim 1, wherein the reflection film is a reflection-increasing layer or an anti-reflection layer, and the reflection-increasing layer is adapted to increase a reflectivity of light projected onto the glass layer provided with the reflection-increasing layer, and the anti-reflection layer is adapted to decrease a reflectivity of light projected onto the glass layer provided with the anti-reflection layer.

6. The laminated glass according to claim 4, wherein one of the reflection films is a reflection-increasing layer, and the other thereof is an anti-reflection layer.

7. The laminated glass according to claim 1, wherein the reflection film is a monolayer reflection film or a multilayer reflection film.

8. The laminated glass according to claim 1, wherein the reflection-increasing layer causes a reflectivity of light projected onto the glass layer provided with the reflection-increasing layer to reach up to 6-9%.

9. The laminated glass according to claim 1, wherein the anti-reflection layer causes a reflectivity of light projected onto the glass layer provided with the anti-reflection layer to reach up to 0.1-1%.

10. A front windshield of a vehicle, which employs the laminated glass according to claim 1.

11. The laminated glass according to claim 8, wherein the reflection-increasing layer causes a reflectivity of light projected onto the glass layer provided with the reflection-increasing layer to reach up to 9%.

12. The laminated glass according to claim 9, wherein the anti-reflection layer causes a reflectivity of light projected onto the glass layer provided with the anti-reflection layer to reach up to 0.1%.
